(19) United States
(12) Patent Application Publication
(10) Pub. No.: US 2012/0069186 A1
(43) Pub. Date: Mar. 22, 2012

(54) Parking-Assist Apparatus and Method

(76) Inventor: Jonathan Keith Ross, Bristol (GB)

(21) Appl. No.: 13/239,482

(22) Filed: Sep. 22, 2011

(30) Foreign Application Priority Data
Sep. 22, 2010 (GB) 10 15 906.9

(51) Int. Cl. B60Q 1/48; H04N 7/18

(52) U.S. Cl. 348/148; 340/932.2; 348/E07.085

(57) ABSTRACT

A parking-assist system for a car comprises at least one sensor suitable to be attached to a car and configured to create output signals, a wireless s transmitter connected to the sensor; and a device equipped with a wireless receiver. The device is configured to wirelessly receive the signals from the sensor via the wireless transmitter, and provide an indication of the signals.

### CROSS REFERENCE TO RELATED APPLICATIONS

This application claims priority from United Kingdom Patent Application No. GB 10 15 906.9, filed Sep. 22, 2010, the entire disclosure of which is incorporated herein by reference in its entirety.

### BACKGROUND OF THE INVENTION

1. Field of the Invention

The present invention relates to a system for assisting drivers with parking cars.

2. Description of the Related Art

Many people find it difficult to park their car, and most people have trouble parking an unfamiliar car. It is difficult to know exactly how much distance is available between the rear of the car and nearby objects. In addition, some objects are out of the line of sight, such as low bollards and small children.

It is known, therefore, for luxury cars to be fitted with parking sensors that sense the distance from the car to nearby objects, and cameras that provide a rear view. It is also possible to buy such systems to retrofit onto older or less expensive cars. However, these retrofit systems require lengths of cabling to be installed, invisibly if possible, and also require an output device to be placed on the dashboard. For many cars already laden with dashboard equipment such as satellite navigation devices, this is a bulky, expensive and difficult to install solution.

### BRIEF SUMMARY OF THE INVENTION

According to an aspect of the present invention, there is provided a parking-assist apparatus for a motor vehicle, comprising: at least one senor suitable to be attached to a car and configured to create output signals; a wireless transmitter connected to said sensor; and a mobile cellular telephone configured to wirelessly receive said output signals from said sensor via said wireless transmitter, and to provide an indication of said signals.

### BRIEF DESCRIPTION OF THE DRAWINGS

FIG. 1 illustrates an automobile provided with a parking-assist system as described herein;

FIG. 2 is a diagram of the parking-assist system installed in the automobile shown in FIG. 1;

FIG. 3 is a diagram of a mobile cellular telephone shown in FIG. 3;

FIG. 4 illustrates steps carried out by the telephone shown in FIG. 3;

FIG. 5 details steps carried out during FIG. 4 to receive output data; and

FIG. 6 illustrates the telephone shown in FIG. 3 mounted on the dashboard of the car shown in FIG. 1.

### DETAILED DESCRIPTION OF EXAMPLE EMBODIMENTS

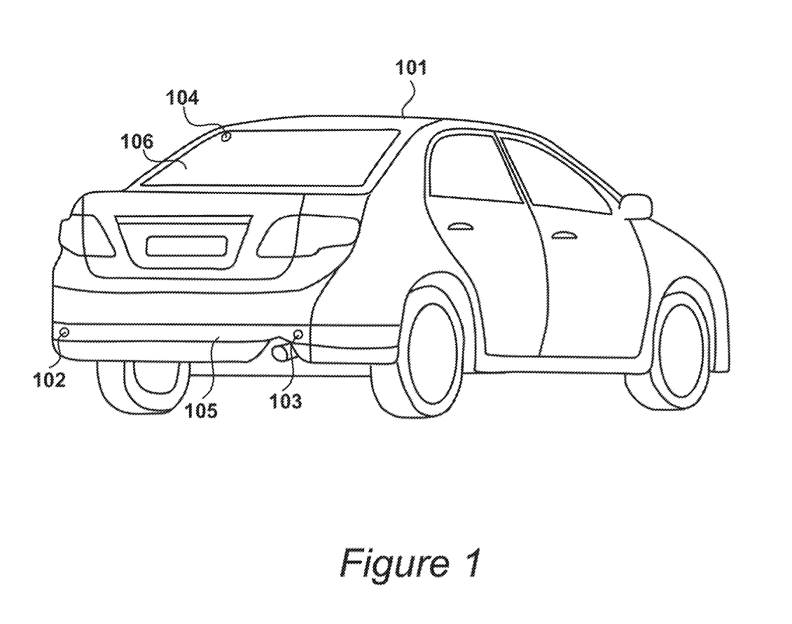

### FIG. 1

An automobile 101 is shown in FIG. 1. It is provided with two distance sensors 102 and 103 and a camera device 104. In this example, distance sensors 102 and 103 are installed in the bumper 105 of car 101, while camera device 104 is installed on the inside of rear windscreen 106. However, any of the sensors may be attached with a clip or any other securing means, internally or externally, to the front or rear of the vehicle.

The driver of automobile 101 is assisted in parking by output signals from distance sensors 102 and 103 and camera device 104, which are transmitted to and output from a mobile cellular telephone.

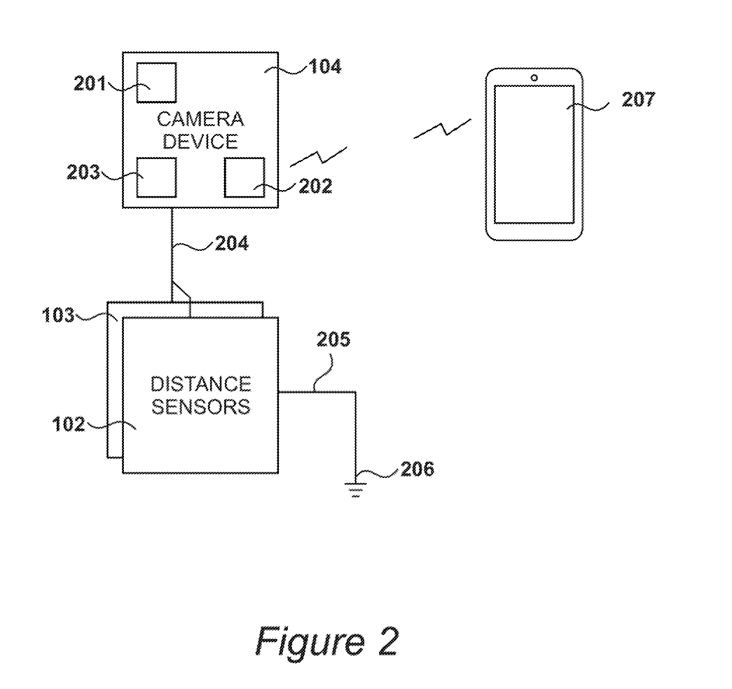

### FIG. 2

Camera device 104 includes, within a casing, a camera 201, a transceiver 202, and an internal power source provided by battery pack 203. Distance sensors 102 and 103 are connected to camera device 104, and thereby to transceiver 202, by wiring 204, and power is provided to distance sensors 102 and 103 via wiring 205, which draws power from the automobile's internal wiring 206. In alternative embodiments, the distance sensors have internal power sources and/or communicate wirelessly with transceiver 202.

Thus in this example the sensors are provided by distance sensors 102 and 103 and camera 201. However, other numbers and types of sensors may be used. To embody the invention, only one sensor, such as camera 201, is necessary.

Transceiver 202 communicates wirelessly with mobile cellular telephone 207. This communication may be by Bluetooth® or any other wireless communication means.

In this embodiment a mobile cellular telephone is used as the output device, because the driver is likely to be carrying it with him in the automobile. However, other output devices may be used that are capable of wireless communication. For example, an existing satellite navigation device installed on the dashboard of the automobile could be used, if it supported wireless transmission.

Sensors 102, 103 and 201 produce output signals appropriate to their function, and these are relayed via transceiver 202 to mobile cellular telephone 207, which outputs them appropriately.

In an alternative embodiment, the transceiver may be a separate item and not in the same casing as any of the sensors, in which case any of the sensors may communicate with the transceiver wirelessly or via wires.

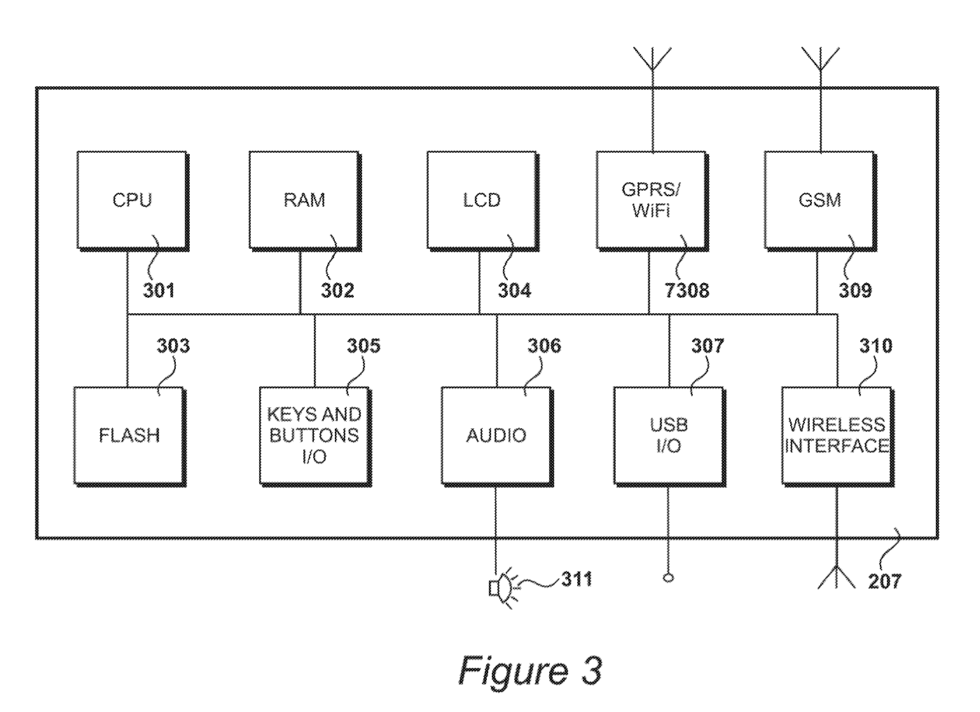

### FIG. 3

FIG. 3 is a diagram of mobile cellular telephone 207. It includes a CPU 301 with a clock speed of 400 megahertz (MHz) with memory 302 being provided by 64 MB of RAM. 256 MB of non-volatile FLASH memory 303 is provided for program and data storage. Liquid crystal display 304 is used to display information to the user. Input/output 305 processes the input of the keys and buttons while audio input/output 306 provides a microphone and speaker interface for use with the telephone facility, and connects to a speaker 311.

Universal Serial Bus (USB) input/output 307 is used to connect the telephone to a computer. GPRS/WiFi connection 308, GSM connection 309 and a wireless interface 310, in this example provided by the Bluetooth® protocol, enable the telephone to connect to wireless networks and to a mobile telephone operator.

The telephone described here is an example of a device that may be used in the described system. However, any mobile cellular telephone capable of wireless transmission can be used. Alternatively, another wireless device capable of outputting signals in some form could be used.

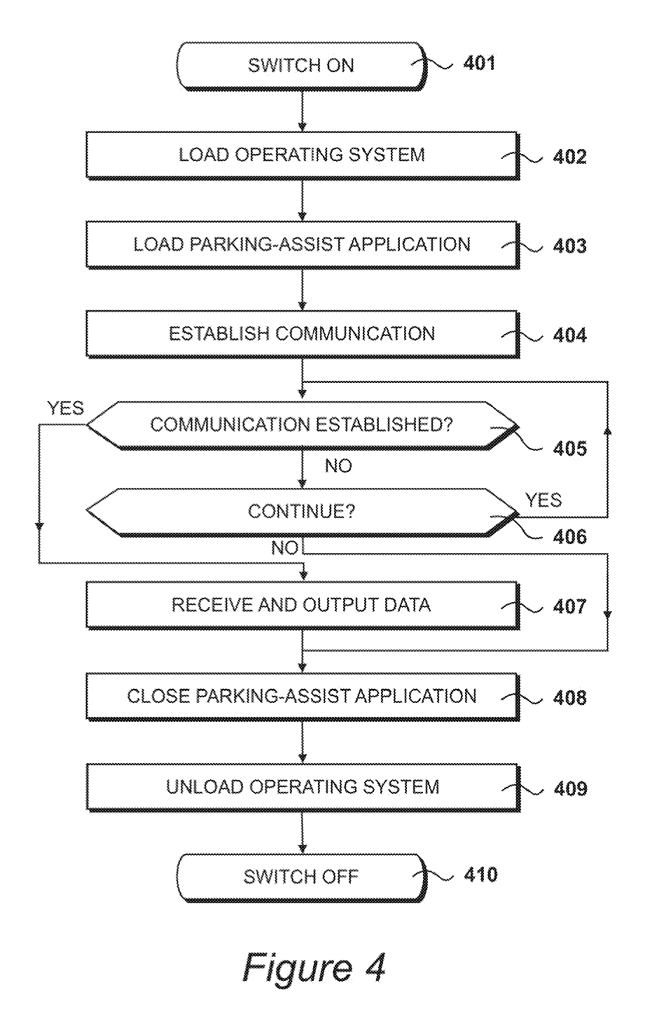

### FIG. 4

Steps carried out by mobile cellular telephone 207 are detailed in FIG. 4. At step 401 it is powered on and at step 402 the operating system is loaded. At step 403, either automatically or in response to user input, a parking-assist application is loaded and at step 404 an attempt is made to establish a wireless connection with transceiver 202.

At step 405 a question is asked as to whether this was successful, and if this question is answered in the negative then at step 406 a question is asked as to whether to continue. This is answered by user input indicating whether to try again, and if it is answered in the affirmative then control is returned to step 404 and a connection attempt is made again. However, if the question is answered in the negative then the sensing application is closed at step 408.

However, if a connection is successfully established then at step 407 the telephone receives data from transceiver 202 and outputs it. At step 408 the parking-assist application is closed. Eventually, the operating system will be unloaded at 409 and the telephone is switched off at step 410.

As an alternative implementation, the telephone may automatically establish a connection with transceiver 202 whenever it is in range, and open the parking-assist application automatically. As a further alternative, the telephone may be able to output data without opening a dedicated application.

Still further, the transceiver could be a transmitter only, constantly transmitting output signals. In this case, the mobile device need only have a receiver that listens for signals on the appropriate wireless frequency, and no connection would be established between the transmitter and receiver.

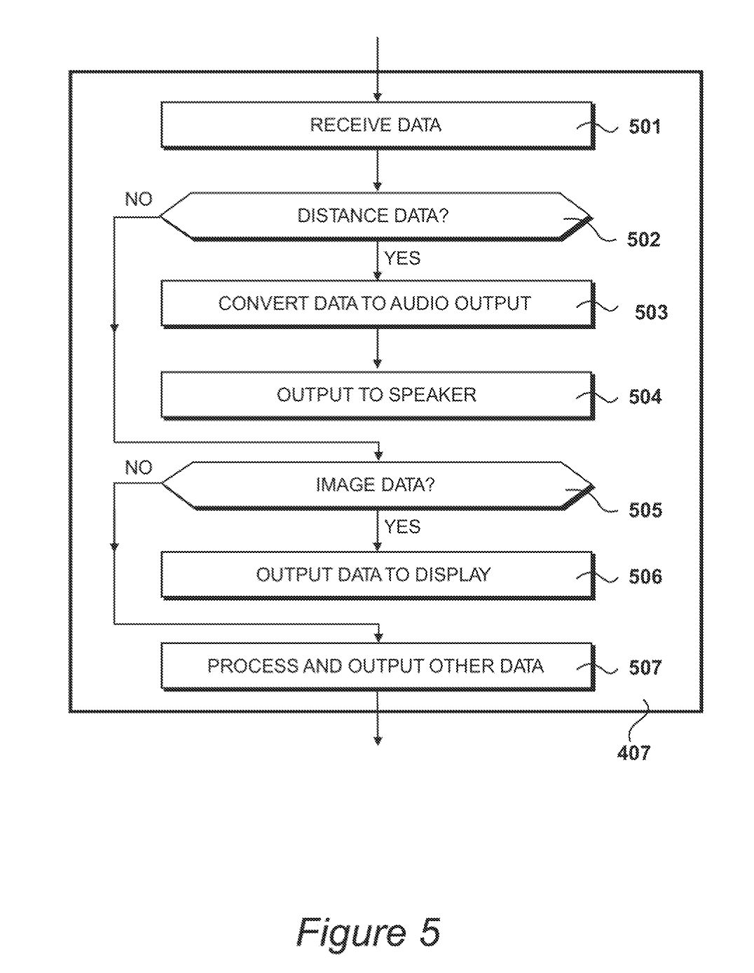

### FIG. 5

FIG. 5 details step 407 at which output data is received. The data received from transceiver 202 varies depending upon the type of sensor it is coming from. Thus, for example, camera 201 is configured to produce image data, while distance sensors 102 and 103 are configured to produce an indication of distance. Other sensors would be configured to output different types of data.

Thus, at step 501 data is received and at step 502 a question is asked as to whether this is distance data. If this question is answered in the affirmative then at step 503 the data is converted into audio output which is output to speaker 311 at step 504. Typically, this audio output consists of a series of beeps, which become either shorter, closer together or more high pitched as the distance provided by the distance sensor decreases.

If the question asked at step 502 is asked answered in the negative, then at step 505 a question is asked as to whether it is image data, and if this question is answered in the affirmative then it is output to display 304 at step 506.

If the question asked at step 505 is answered in the negative, then other data has been received and it is processed and output at step 507.

In alternative embodiments, signal processing may be done either at the sensors, or at transceiver 202. For example, the distance sensors may, instead of outputting distance data, output audio data. Thus, the sensing application should be configured to receive many types of data, convert them if necessary and output them to the correct output means.

It is envisaged that in other embodiments the vibration function of mobile telephone 207 could be utilised, such that instead of beeps to indicate distance, the output is bursts of vibration. Other types of output are also envisaged.

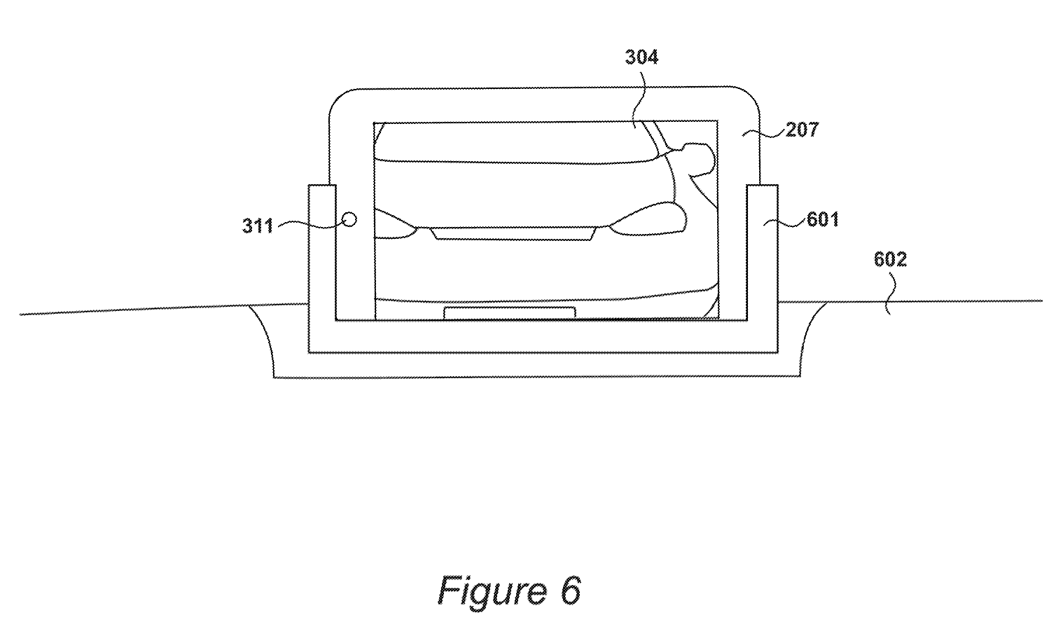

### FIG. 6

An advantage of this invention is that the driver of automobile 101 does not need to install a dashboard display in his automobile. Indeed, if the telephone can connect automatically to transceiver 202 he need not even take it out of his pocket for it to be used as an output device for the parking sensors. However, should he wish to conveniently view data produced by a camera, he may mount it in a cradle 601 on the dashboard 602 of automobile 101, as shown in FIG. 6. As shown, LCD display 304 provides the image data produced by camera 201, while speaker 311 is producing audio signals indicative of distance.

Other embodiments of the invention are possible. For example, in a automobile already provided with Bluetooth® for hands-free communication via a mobile cellular telephone, it may be possible to use this to provide the wireless communication with the sensors. If a desired output device does not have wireless capability, such as many common satellite navigation devices, it may be connected to an additional wireless transceiver.

In all of these embodiments, the requirement for cabling running the length of the car, which can be difficult to hide and maintain, is eliminated, and it is not necessary to install a dedicated output device on the dashboard, but an existing device may be used.

What we claim is:

1. A parking-assist apparatus for a motor vehicle, comprising:
at least one sensor suitable to be attached to a car and configured to create output signals;
a wireless transmitter connected to said sensor; and
a mobile cellular telephone configured to:
wirelessly receive said output signals from said sensor via said wireless transmitter, and
provide an indication of said signals.

2. The parking-assist apparatus of claim 1, wherein said transmitter is contained within the same casing as said sensor.

3. The parking-assist apparatus of claim 1, wherein:
said sensor is a distance sensor configured to determine the distance to a nearby object;
said output signals vary depending on said distance determined by said sensor; and
said mobile telephone is equipped with a speaker and is configured to provide an auditory indication of said signals via said speaker.

4. The parking assist apparatus of claim 3, wherein said auditory indication is a series of sounds, and the gap between said sounds decreases as the distance determined by said sensor decreases.

5. The parking assist apparatus of claim 1, wherein:
said sensor is a camera;
said output signals are images produced by said camera; and
said mobile telephone is equipped with a visual display and is configured to display said images on said display.

6. The parking-assist apparatus of claim 1, wherein said wireless transmitter and said wireless receiver communicate using the Bluetooth® protocol.

7. The parking-assist apparatus of claim 1, wherein said wireless transmitter is a wireless transceiver.

8. The parking-assist apparatus of claim 1, wherein said wireless receiver is a wireless transceiver.

9. The parking-assist system of claim 1, wherein said device is a satellite navigation device.

10. A method of fitting a parking-assist system to a motor vehicle, comprising the steps of:
fitting at least one sensor to said car, said sensor being configured to create output signals; and
fitting a wireless transmitter to said car and connecting it to said sensor to receive said output signals and transmit them;
wherein said system is configured to communicate with a cellular mobile telephone that wirelessly receives said output signals from said transmitter and provides an indication of said signals.

11. The method of claim 10, wherein:
said sensor is a distance sensor configured to determine the distance to a nearby object; and
said output signals vary depending on said distance determined by said sensor.

12. The parking assist system of claim 10, wherein:
said sensor is a camera; and
said output signals are images produced by said camera.

13. The method of claim 10, wherein said steps of fitting a sensor and fitting a transmitter comprise the single step of fitting an sensor and transmitter contained in the same casing.

14. The method of claim 13, wherein said casing further includes a power pack.

15. The method of claim 10, further comprising the step of providing wired connection between said sensor and said transmitter.

16. The method of claim 10, further comprising the step of installing wires to provide power to said sensor.

17. The method of claim 10, wherein said wireless transmitter communicates using the Bluetooth® protocol.

18. The method of claim 10, wherein said transmitter is a transceiver.

19. The method of claim 10, further comprising the step of installing at least one further sensor and connecting it to said transmitter.
